(19) United States
(12) Patent Application Publication
(10) Pub. No.: US 2012/0054773 A1
(43) Pub. Date: Mar. 1, 2012

(54) PROCESSOR SUPPORT FOR SECURE DEVICE DRIVER ARCHITECTURE

(75) Inventors: William Eric Hall, Clinton, CT (US); Marcel C. Rosu, Ossining, NY (US)

(73) Assignee: International Business Machines Corporation, Armonk, NY (US)

(21) Appl. No.: 12/873,085

(22) Filed: Aug. 31, 2010

(51) Int. Cl. G06F 9/48; G06F 12/14

(52) U.S. Cl. 718/108

(57) ABSTRACT

A system to increase the security of the state of interrupted applications may include a computer processor to process software running in a plurality of runtime environments. The system may also include an interrupt stack per runtime environment to assist in how the computer processor switches from one subroutine to another in the same environment and from one runtime environment to any of the other runtime environments. The system may further include a plurality of hardware-managed areas to store processor state information and to assist in how the computer processor switches from one runtime environment to any of the other runtime environments.

### CROSS-REFERENCE TO RELATED APPLICATIONS

This application contains subject matter related to the following co-pending applications entitled “RESOURCE MANAGEMENT AND SECURITY SYSTEM” and having an attorney docket number of YOR920090081US1, and “FILESYSTEM MANAGEMENT AND SECURITY SYSTEM” and having an attorney docket number of YOR920090082US1, the entire subject matters of which are incorporated herein by reference in their entirety. The aforementioned applications are assigned to the same assignee as this application, International Business Machines Corporation of Armonk, N.Y.

### BACKGROUND

The invention relates to the field of computer systems, and, more particularly, to address device driver management and security of such.

Commercial operating systems may host all device drivers in the kernel address space. Virtualization architectures may host device drivers in a special input/output (“I/O”) partition in an I/O kernel environment when devices are shared between virtual machines (“VMs”) or in the guest operating system (“OS”) kernel, when devices are dedicated to the VM. Such hosting solutions may be appropriate when the environment hosting the driver, typically a kernel environment, is more privileged than the applications running on top of it.

Most general purpose computers utilize an operating system (“OS”) as an interface between their applications and the computer hardware. As such, the OS usually manages data processing application programs executing on the computer as well as controlling the hardware resources responsive to the data application programs. A data processing application is an application that processes data. A user application may be a data processing application that processes data directly in support of one of the computer's users. A system application may be a data processing application processing data in support of one or multiple user or system applications running on the same or a remote system. System applications are typically implemented as user-level applications running with special privileges and commonly referred to as system daemons.

In addition, the portion of the OS that may control other portions of the OS is usually called the OS kernel. The OS kernel usually has complete access to the application address space and files.

### SUMMARY OF THE INVENTION

According to one embodiment of the invention, a system to increase the security of the state of interrupted applications may include a computer processor to process software running in a plurality of runtime environments. The system may also include an interrupt stack per runtime environment to assist in how the computer processor switches from one subroutine to another in the same environment and from one runtime environment to any of the other runtime environments. The system may further include a plurality of hardware-managed areas to store processor state information and to assist in how the computer processor switches from one runtime environment to any of the other runtime environments.

The computer processor may apply extensions to the processor state information to indicate which processor state information should be stored in the hardware-managed area instead of the interrupt stack. The computer processor may apply extensions to the processor state information to indicate which runtime environment the processor was executing software in before transitioning to the current runtime environment.

The hardware-managed area may include a memory that cannot be referenced by software. The size of the hardware-managed memory area may be at least a multiple of the processor state and the memory area is used as a stack when the processor changes runtime environments. The hardware-managed area may include a memory that cannot be referenced by software other than when running in a trusted runtime environment.

The number of runtime environments may include one environment assigned for all applications in the system. The hardware-managed area may include a plurality of memory areas, each runtime environment is assigned one of the hardware-managed areas, and the size of each of the memory areas is substantially equal to the size of a processor state. Wherein upon a change in the preceding runtime environment, a fraction of the memory area assigned to a currently executing environment may be used to save the processor state except for the processor state information that identifies the currently executing environment, and a fraction of the memory area assigned to the next runtime environment may be used to save a processor state that identifies the currently running environment.

The hardware-managed memory area's size may be at least a multiple of the processor state, the memory area may be used as a stack when the processor changes runtime environments, and software running in a trusted environment may handle stack overflow conditions using memory areas accessible to software running in the trusted environment. The hardware-managed area may include a plurality of smaller memory areas and each runtime environment is assigned two such areas, where both areas may be managed as stacks, where the size of the first area may be at least the size of the processor state other than information regarding the currently executing environment multiplied by a number of exception vector handlers assigned to the environment, and where the size of the second area may be at least the size of the processor state identifying the currently executing environment multiplied by the number of exception vector handlers assigned to the environment. The interrupt stacks and hardware-managed area may include non-pageable memory.

Another aspect of the invention is a method to increase the security of the state of interrupted applications. The method may include processing software running in a plurality of runtime environments with a computer processor. The method may also include using an interrupt stack per runtime environment to assist in how the computer processor switches from one subroutine to another in the same environment and from one runtime environment to any of the other runtime environments. The method may further include providing a plurality of hardware-managed areas to store processor state information and to assist in how the computer processor switches from one runtime environment to any of the other runtime environments.

The method may additionally include applying extensions to the processor state information that indicate which processor state information should be stored in the hardware-managed area instead of the interrupt stack. The method may also include applying extensions to the processor state information that indicate which runtime environment the processor was executing software in before transitioning to the current runtime environment.

The method may further include preventing the hardware-managed area from being referenced by software. The method may additionally include preventing the hardware-managed area from being referenced by software other than when running in a trusted runtime environment.

The method may further comprise including in the number of runtime environments one environment assigned for all applications in the system. The method may also include providing the hardware-managed area as a plurality of memory areas, assigning each runtime environment one of the hardware-managed areas, and sizing each of the memory areas as substantially equal to the size of a processor state.

Another aspect of the invention is a system including a computer processor to process software running in a plurality of runtime environments. The system may also include an interrupt stack per runtime environment to assist in how the computer processor switches from one subroutine to another in the same environment and from one runtime environment to any of the other runtime environments. The system may further include a plurality of hardware-managed areas comprising a memory that cannot be referenced by software that stores processor state information and assists in how the computer processor switches from one runtime environment to any of the other runtime environments, and the number of runtime environments includes one environment assigned for all applications in the system.

### BRIEF DESCRIPTION OF THE DRAWINGS

FIG. 1 is a schematic block diagram of a system to increase the security of the state of interrupted applications in a computer system in accordance with the invention.

FIG. 2 is a flowchart illustrating method aspects according to the invention.

FIG. 3 is a flowchart illustrating method aspects according to the method of FIG. 2.

FIG. 4 is a flowchart illustrating method aspects according to the method of FIG. 2.

FIG. 5 is a flowchart illustrating method aspects according to the method of FIG. 2.

FIG. 6 is a flowchart illustrating method aspects according to the method of FIG. 2.

FIG. 7 is a flowchart illustrating method aspects according to the method of FIG. 2.

FIG. 8 is a flowchart illustrating method aspects according to the method of FIG. 2.

### DETAILED DESCRIPTION

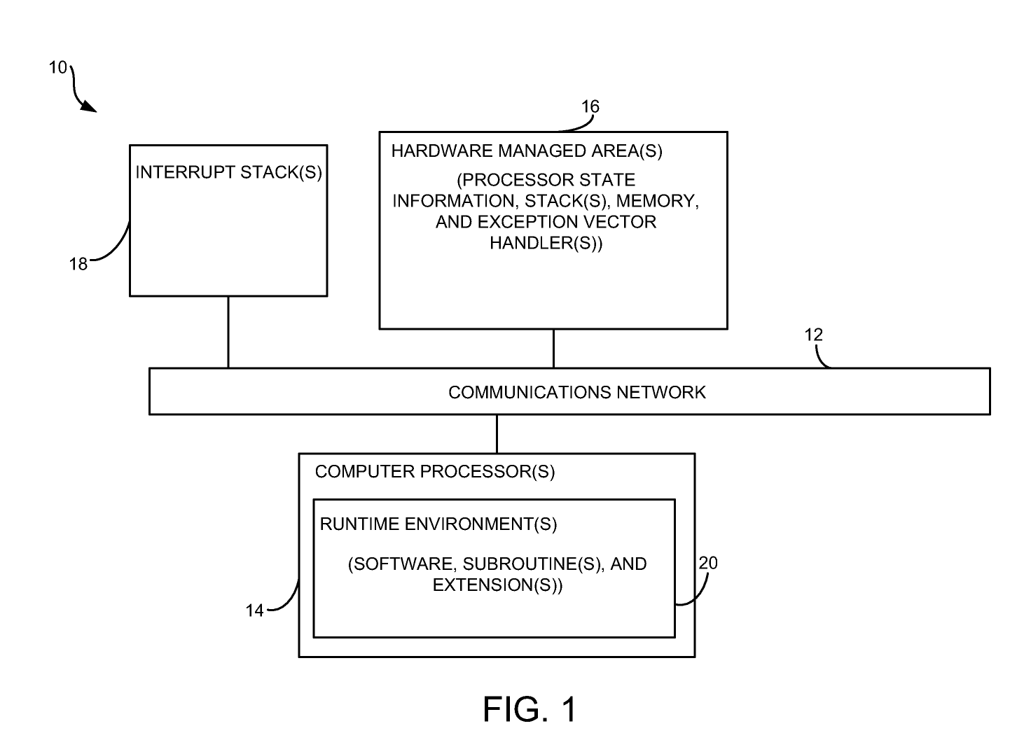

With reference now to FIG. 1, a system 10 to increase the security of the state of interrupted applications in a computer system is initially described. The system 10 is a programmable apparatus that stores and manipulates data according to an instruction set as will be appreciated by those of skill in the art.

In one embodiment, the system 10 includes a communications network 12, which enables a signal to travel anywhere within system 10 between computer processor(s) 14, hardware managed area(s) 16, interrupt stack(s) 18, and/or other data processing resources (not shown). The communications network 12 is wired and/or wireless, for example. The communications network 12 is local and/or global with respect to system 10, for instance.

According to one embodiment, the system includes an interrupt stack 18 per runtime environment 20 to assist in how the computer processor 14 switches from one subroutine to another in the same environment and from one runtime environment to any of the other runtime environments. In an embodiment, the system 10 has the hardware-managed areas 16 store processor 14 state information, and assists in how the computer processor switches from one runtime environment 20 to any of the other runtime environments. Hardware managed means that there is no software in the system to manage the data structure, for example, and therefore the data structure cannot be compromised by a software attack.

In one embodiment, the computer processor 14 applies extensions to the processor state information to indicate which processor state information should be stored in the hardware-managed area 16 instead of the interrupt stack 18. In an embodiment, the computer processor 14 applies extensions to the processor state information to indicate which runtime environment 20 the processor was executing software in before transitioning to the current runtime environment.

In one embodiment, the hardware-managed area 16 includes a memory that cannot be referenced by software. In an embodiment, the size of the hardware-managed memory area 16 is at least a multiple of the processor 14 state, and the memory area is used as a stack when the processor changes runtime environments. In an embodiment, the hardware-managed area 16 includes a memory that cannot be referenced by software other than when running in a trusted runtime environment 20.

In one embodiment, the number of runtime environments 20 includes one environment assigned for all applications in the system 10. In an embodiment, the hardware-managed area 16 includes a plurality of memory areas, each runtime environment 20 is assigned one of the hardware-managed areas, and the size of each of the memory areas is substantially equal to the size of a processor 14 state. In an embodiment, wherein upon a change in the preceding runtime environment 20, a fraction of the memory area assigned to a currently executing environment may be used to save the processor 14 state except for the processor state information that identifies the currently executing environment, and a fraction of the memory area assigned to the next runtime environment may be used to save a processor state that identifies the currently running environment.

In one embodiment, the hardware-managed memory area's 16 size is at least a multiple of the processor 14 state, the memory area may be used as a stack when the processor changes runtime environments 20, and software running in a trusted environment may handle stack overflow conditions using memory areas accessible to software running in the trusted environment. In an embodiment, the hardware-managed area 16 includes a plurality of smaller memory areas and each runtime environment 20 is assigned two such areas, where both areas may be managed as stacks, where the size of the first area may be at least the size of the processor 14 state other than information regarding the currently executing environment multiplied by a number of exception vector handlers assigned to the environment, and where the size of the second area is at least the size of the processor state identifying the currently executing environment multiplied by the number of exception vector handlers assigned to the environment. In an embodiment, the interrupt stacks 18 and hardware-managed area 16 include non-pageable memory.

Another aspect of the invention is a system 10 including a computer processor 14 to process software running in a plurality of runtime environments 20. The system 10 include an interrupt stack 18 per runtime environment 20 to assist in how the computer processor 14 switches from one subroutine to another in the same environment and from one runtime environment to any of the other runtime environments. The system 10 further includes a plurality of hardware-managed areas 16 comprising a memory that cannot be referenced by software that stores processor 14 state information and assists in how the computer processor switches from one runtime environment 20 to any of the other runtime environments, and the number of runtime environments includes one environment assigned for all applications in the system.

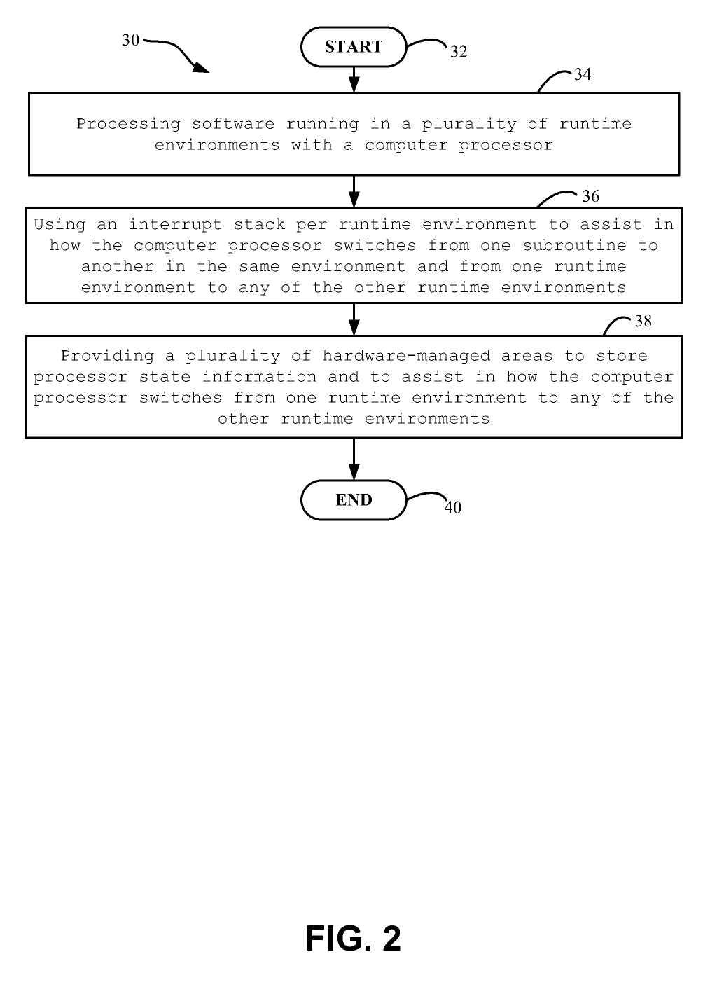

Another aspect of the invention is a method to increase the security of the state of interrupted applications, which is now described with reference to flowchart 30 of FIG. 2. The method begins at Block 32 and may include processing software running in a plurality of runtime environments with a computer processor at Block 34. The method may also include using an interrupt stack per runtime environment to assist in how the computer processor switches from one subroutine to another in the same environment and from one runtime environment to any of the other runtime environments at Block 36. The method may further include providing a plurality of hardware-managed areas to store processor state information and to assist in how the computer processor switches from one runtime environment to any of the other runtime environments at Block 38. The method ends at Block 40.

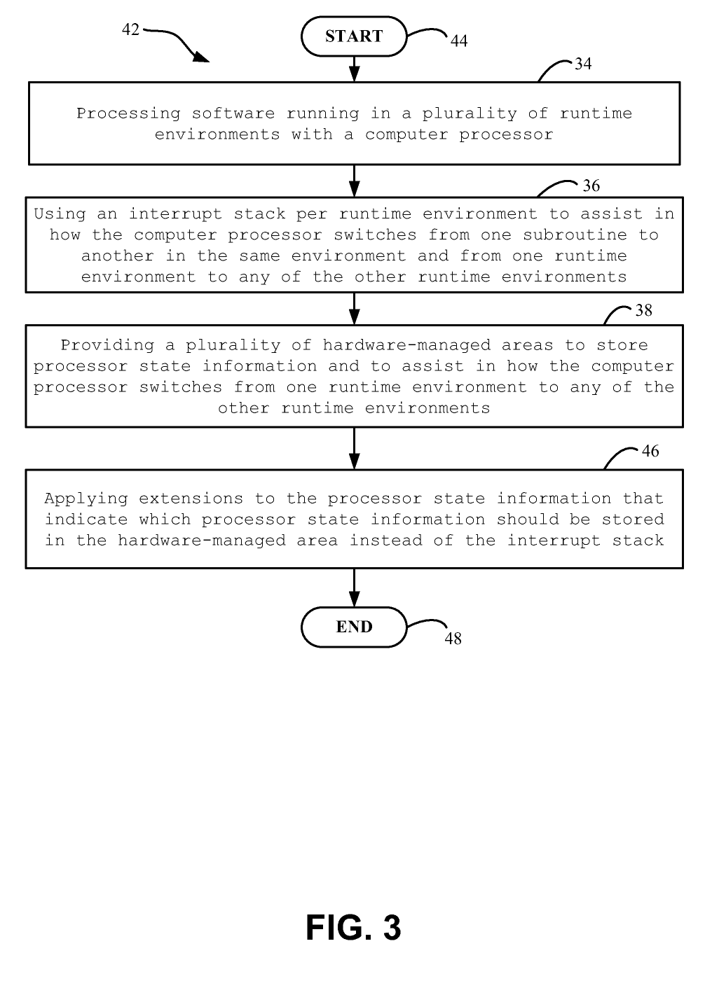

In another method embodiment, which is now described with reference to flowchart 42 of FIG. 3, the method begins at Block 44. The method may include the steps of FIG. 2 at Blocks 34, 36, and 38. The method may additionally include applying extensions to the processor state information that indicate which processor state information should be stored in the hardware-managed area instead of the interrupt stack at Block 46. The method ends at Block 48.

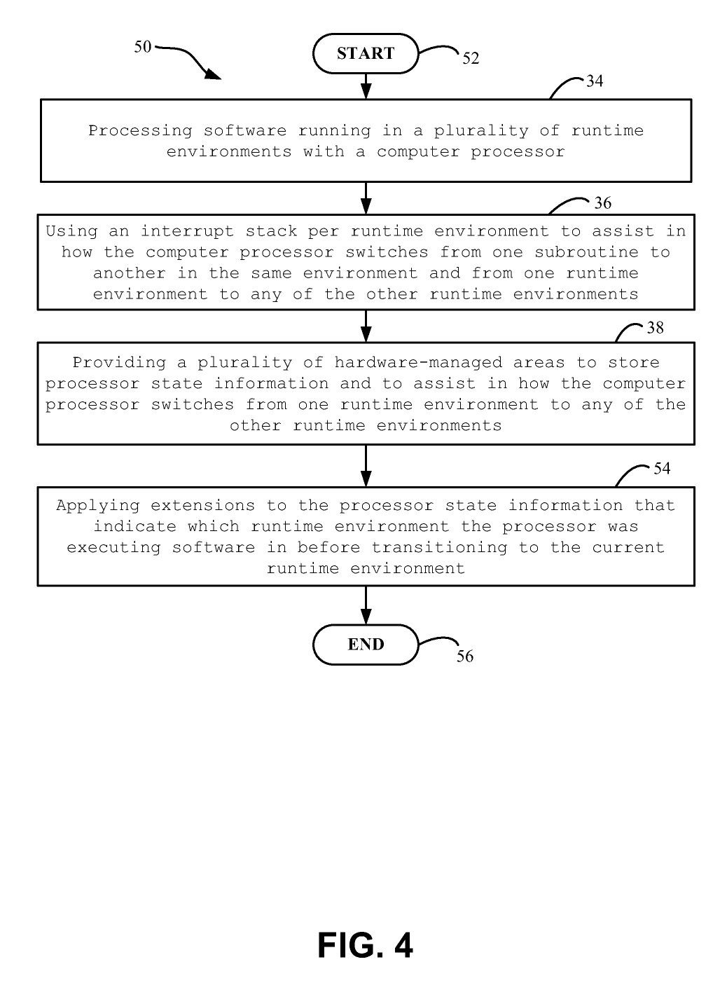

In another method embodiment, which is now described with reference to flowchart 50 of FIG. 4, the method begins at Block 52. The method may include the steps of FIG. 2 at Blocks 34, 36, and 38. The method may also include applying extensions to the processor state information that indicate which runtime environment the processor was executing software in before transitioning to the current runtime environment at Block 54. The method ends at Block 56.

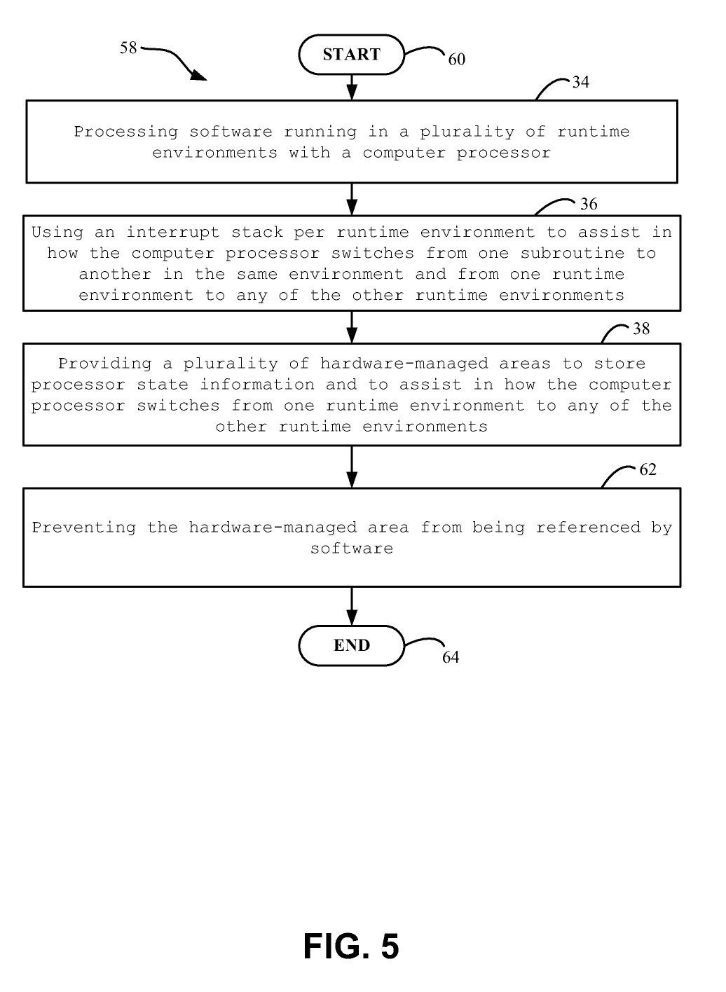

In another method embodiment, which is now described with reference to flowchart 58 of FIG. 5, the method begins at Block 60. The method may include the steps of FIG. 2 at Blocks 34, 36, and 38. The method may further include preventing the hardware-managed area from being referenced by software at Block 62. The method ends at Block 64.

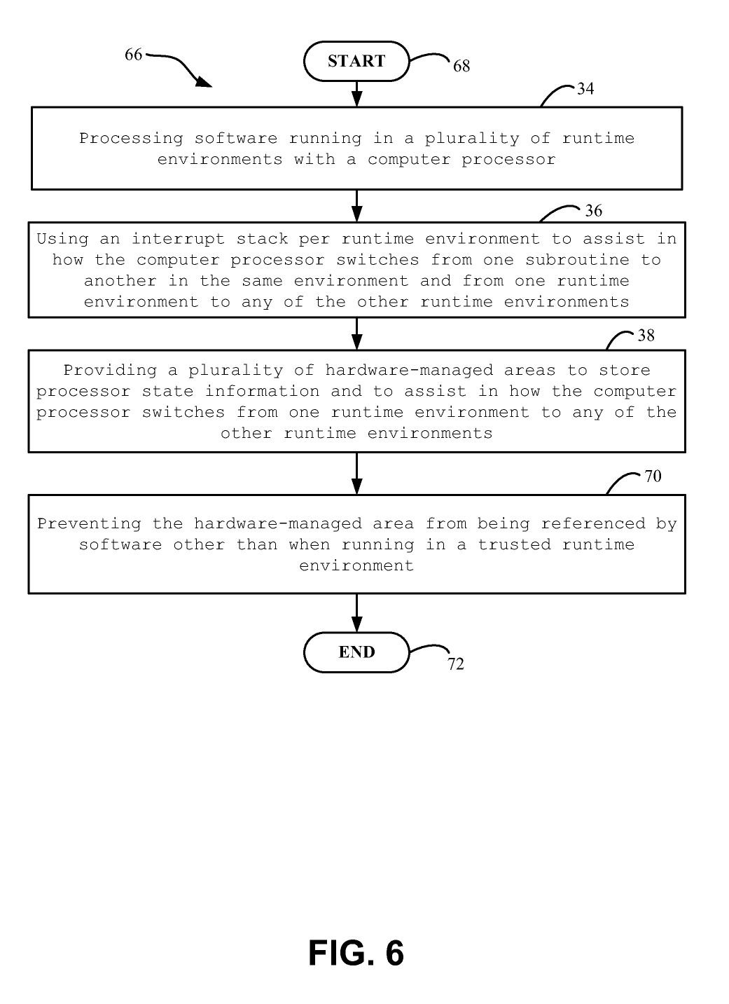

In another method embodiment, which is now described with reference to flowchart 66 of FIG. 6, the method begins at Block 68. The method may include the steps of FIG. 2 at Blocks 34, 36, and 38. The method may further include preventing the hardware-managed area from being referenced by software other than when running in a trusted runtime environment at Block 70. The method ends at Block 72.

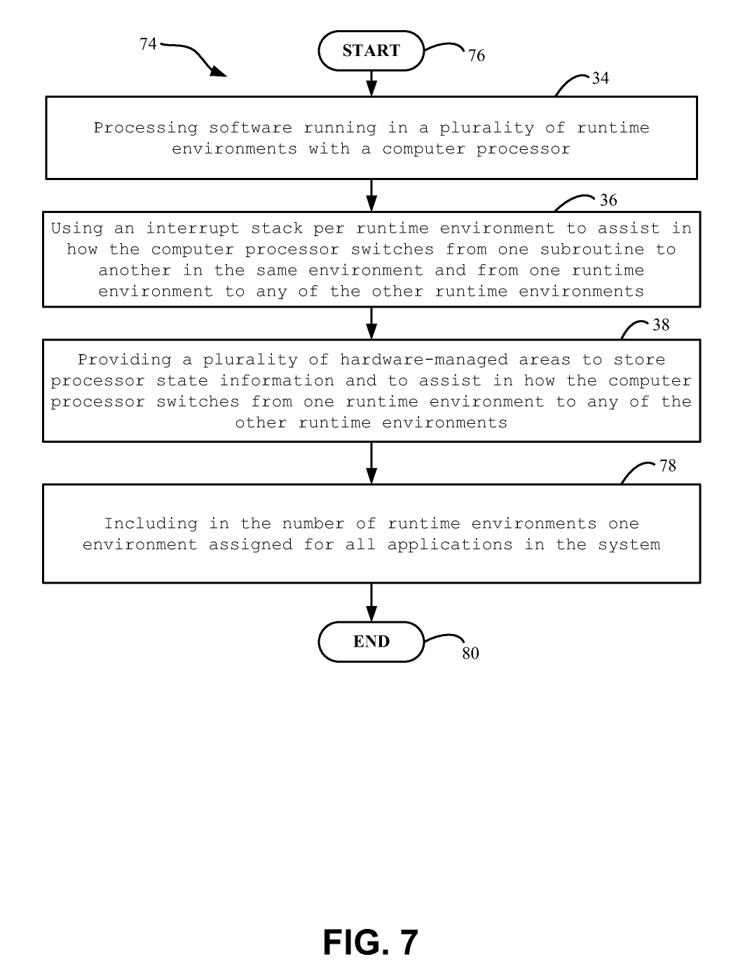

In another method embodiment, which is now described with reference to flowchart 74 of FIG. 7, the method begins at Block 76. The method may include the steps of FIG. 2 at Blocks 34, 36, and 38. The method may further comprise including in the number of runtime environments one environment assigned for all applications in the system at Block 78. The method ends at Block 80.

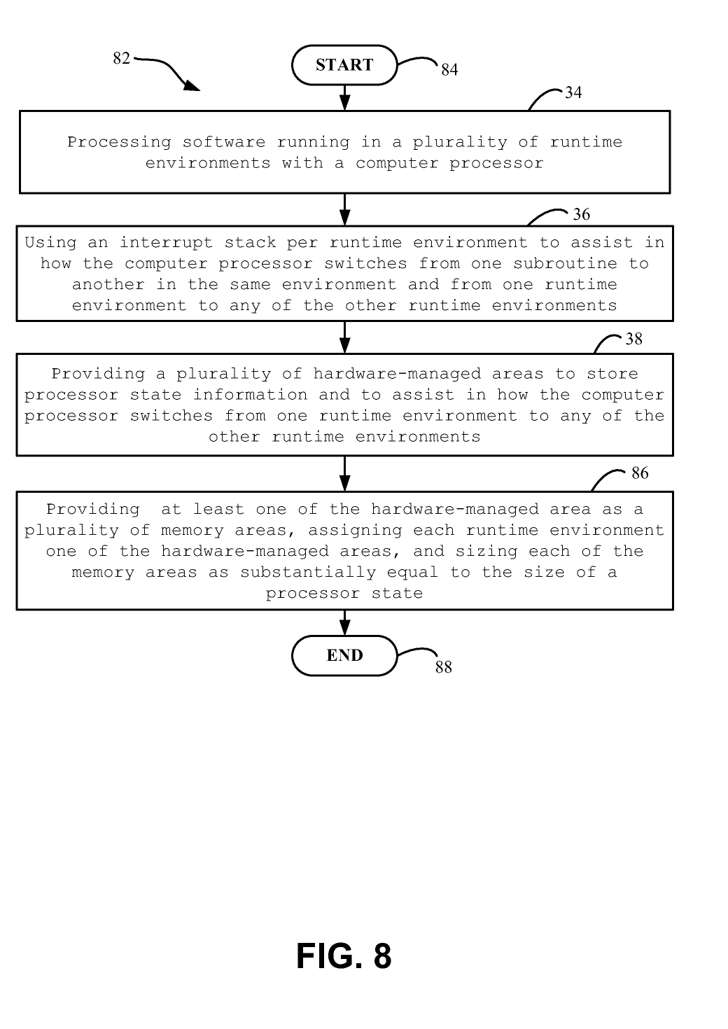

In another method embodiment, which is now described with reference to flowchart 82 of FIG. 8, the method begins at Block 84. The method may include the steps of FIG. 2 at Blocks 34, 36, and 38. The method may further include providing the hardware-managed area as a plurality of memory areas, assigning each runtime environment one of the hardware-managed areas, and/or sizing each of the memory areas as substantially equal to the size of a processor state at Block 86. The method ends at Block 88.

In view of the foregoing, the system 10 addresses the security of the state of interrupted applications in a computer system, for example. Previous hosting solutions are appropriate when the environment hosting the driver, typically a kernel environment, is more privileged than the applications running on top of it. When this assumption is not true or when the drivers do not trust each other, they have to be hosted in different runtime environments (where a runtime is an address space with data, code plus the content of the processor registers while running the code in the address space). Environment X does not trust environment Y means that code running under environment Y should not be able to read or modify any of the state of environment X.

For example, consider the simple case of an application not trusting the underlying kernel. Even if the kernel is prohibited from accessing the application address space, any of the device drivers hosted in the kernel environment has access to the application registers upon serving an interrupt taken while executing application code. By modifying the values of these registers (program counter, stack pointer, general purpose registers), the device driver code (hosted by the kernel) can change the application behavior and, potentially, make it reveal its secrets.

In one embodiment, kernel code is part of the OS kernel in commercial or academic operating systems. It runs with super-user privileges and it provides support to all (user and system) applications running on the underlying computer system 10. Super-user mode is the most privileged level at which software runs on a typical computer systems with no hardware support for virtualization or with such support disabled. Software running in the most privileged mode has access to all the hardware resources of the system 10. In system 10, the mediator code is run in the most privileged level and the modified kernel code is run in a mode with slightly fewer privileges. This means that the mediator code has access to all the hardware resources, the modified kernel has access to fewer hardware resources than the mediator (and also less than the original kernel had access to in the unmodified/original computer system) and applications are run in a mode with even fewer privileges than the modified kernel code.

In one embodiment, the system 10 applies extensions to existing processor architectures that are used to save in a trusted area 16 the processor 14 state normally saved on the interrupt stack 18. These extensions are used when such a stack and the associated interrupt service routine are hosted by a runtime environment 20 that is not trusted by the interrupted environment. The processor 14 state refers to the processor general purpose registers, privilege level, condition registers, link registers, and/or the like, which are normally used in computation and managed by a compiler, e.g. can be managed in software, and excludes processor configuration state, typically set at system initialization.

In one embodiment, the hardware managed areas 16 include but are not limited to (A) a dedicated memory that cannot be referenced by software other than when running in the most trusted environment in the system 10, with the memory size set to the maximum number of runtime environments that can be traversed by a chain of nested interrupts (including one environment assigned for all the applications in the system) multiplied by the processor 14 state size; (B) a dedicated memory that cannot be referenced by software other than when running in the most trusted environment in the system (which the most trusted environment should be trusted by every other environment), with the memory size equal to a given multiple of the processor state size; and/or (C) memory areas allocated in the address spaces of the runtime environments 20 that can be traversed by a chain of nested interrupts, with the size of the memory areas greater or equal to the maximum number of interrupt vectors simultaneously enabled for the runtime environment multiplied by the processor state size. Note that for option C, one additional memory area, with size equal to the processor state size, is allocated for the application state, to support the case when the first interrupt in the chain is taken while running one of the multiple applications in the system.

As interrupts can be nested, this processor 14 feature is useful both when taking an interrupt while running application code and when taking an interrupt while servicing another interrupt, when the new interrupt is serviced by a routine hosted by a different runtime environment 20 than the one hosting the ‘interrupted’ interrupt service routine.

In one embodiment, while processing a chain of nested interrupts, the processor 14 alternates between a finite collection of runtime environments 20. For instance, if taking the first interrupt while running application code (environment A), and the driver code is hosted in the kernel (environment K, with environment A not trusting K), the processor 14 has to save the processor state running in environment A in a trusted area before switching its state to environment K. Upon executing the ‘return from interrupt’ (RFI) instruction, the processor 14 restores the environment A state from the trusted area instead of an environment K stack. In this example, the processor alternates between two environments (A and K) and it needs to store only one environment state in the trusted area.

In a little more complex scenario, while servicing the first interrupt, the processor 14 takes a second one; the driver for the second interrupt is also hosted by the K environment. In this scenario, the ISR (Interrupt Service Routine) can save its environment K state in a local stack 18 as it doesn't change trust domains. The state can then be restored by the ISR before executing the RFI instruction corresponding to the second interrupt. Alternatively, the processor 14 can use trusted areas 16 to save and restore its state even when taking interrupts hosted by the current environment.

Consider a similar scenario but with the driver/ISR of the second interrupt hosted in an environment X, which is not trusted by K, which was not trusted by A. Upon taking the second interrupt, the processor 14 can save its environment K state in an additional trusted area 16 (instead on a stack 18 in the environment X) and restore its state from the additional trusted area upon executing the RFI instruction. Note that, in this scenario, the processor has two environment states in trusted areas.

In an even more complex scenario of nested interrupts, the processor 14 takes a third interrupt while serving the second one (goes to depth three: A→K→X→K), with the driver of the third interrupt being hosted in environment K. Upon taking the third interrupt, the processor 14 re-enters runtime environment K to service the interrupt (the following section, on management of trusted areas 16, provides information on the handling of the previously saved state for environment K) and it saves its environment X state in yet another trusted area. Upon returning from the third interrupt, the processor 14 restores the saved environment X from the additional trusted area 16. Note that in contrast to exception handlers, interrupt servicing routines typically do not need access to the interrupted processor state.

Trusted areas and/or hardware-managed stacks 16 are allocated in non-pageable memory (applies to all the following options). Option A: one trusted hardware-managed area 16 per runtime environment 20, about the size of the processor state; in addition, each runtime environment manages an interrupt stack 18 in software. Upon taking an interrupt that switches the runtime environment 20, the interrupted processor 14 state is saved in the trusted area assigned to the interrupted runtime environment and the processor state is restored from the trusted, hardware-managed area 16 of the next environment.

The hardware-managed state of the interrupted environment 20 is marked as being interrupted out, to prevent re-entrance, e.g. prevent interrupts hosted in the interrupted environment from being activated before the current interrupt is being served (and control returned to interrupted environment as a return from interrupt). In one embodiment, the ‘marking’ happens automatically upon taking the interrupt, but the environment 20 can temporarily disable the automatic marking, while running code sections that do not require, or expect, interrupts to return.

The hardware-managed state associated with the ‘new’ environment, where the ISR is hosted, records that the current ISR serves an interrupt that occurred while executing the ‘interrupted’ environment 20 and this is the environment where a “return from interrupt” action has to switch the processor 14 back to.

The ISR corresponding to the new environment 20 preserves the content of the restored processor 14 state on a stack local to its environment, e.g. it saves it upon entry and restores it upon return. Note that this is similar to interrupts that do not require a switch of the runtime environment 20, which also use a stack local 18 to the current environment to save and restore processor 14 state.

Option B: one trusted, hardware-managed area 16 (stack) shared by all runtime environments 20, and overflow condition of this area is handled by software running in the most trusted runtime environment. The dedicated memory is effectively a hardware-managed stack 16, with an optional exception handling routine for the case when the stack overflows, and the size (a multiple of processor state) is selected such that the hardware-managed stack does not overflow during normal system 10 operation. The optional exception routine runs in the most trusted runtime environment 20. Each stack entry includes the information needed to identify the interrupted runtime environment 20, which information can be as simple as an environment ID that the rest of the hardware can interpret properly, or a collection of registers, translation lookaside buffer (TLB) entries, and/or the like, that collectively identify the interrupted environment.

In one embodiment, the processor 14 maintains an additional register which records the interrupt nesting level, and this register points to the top of the hardware managed stack 16 and is visible to software only when running in the most trusted environment 20 in the system 10. After the interrupted processor 14 state is saved, the new state is set to an appropriate value (zeros for general purpose registers and appropriate values for the rest of the processor state, e.g. privilege level, address space, and/or the like) in hardware, which means that the ISR does not have to preserve their content across its execution. Therefore, the ISRs in system 10 can have lower overheads as they do not have to start and end with a sequence of register save and restore instructions, respectively.

Option C: there are two hardware-managed stacks 16 per runtime environment 20: one to store processor 14 state and the other one to store the ID (or relevant information) of the runtime environment 20 the interrupt was taken in. For a given interrupt, the processor 14 state is saved in the first stack associated with the environment, say A, executing at the time the interrupt is taken, while the ID of A, say IDA is saved on the second stack associated with the environment in which the interrupt service routine (ISR) is executing, say B. For each environment 20, its two stacks can be combined into one hardware-managed stack 16 or not.

Upon taking an interrupt, the processor 14 saves its state on the first stack, which is in the address space of the current environment (with the exception of application environments which all may share a trusted state save area) instead of saving it on the stack of the new (potentially untrusted) runtime environment. As in Option B, the processor 14 state is set to appropriate values before running the new environment and therefore, they do not have to be saved and restored by the ISR.

In addition, upon entering the new environment 20, the processor 14 pushes the ID of the interrupted environment on a hardware managed stack 16 that belongs to the new runtime environment 20 (in which the ISR executes).

Overall, each environment 20 has two ‘logical’ hardware-managed stacks 16. In one embodiment, both stacks are allocated in non-pageable memory, as all hardware managed stacks 16 and trusted areas.

The first stack is used to save the processor 14 state upon taking an interrupt that will switch to a new environment 20. Entries in this stack are relatively large as each entry represents almost the entire the processor 14 state.

The second stack is used upon entering the new environment 20 to store the information that identifies the interrupted runtime environment. As in “Option B”, this information can be an environment ID, in which case entries of the second stack are really small, or a collection of several registers, TLB entries, and/or the like. The entries in the second stack represent the processor 14 state not saved in the 1st stack. Both stacks are managed by the hardware 16 and are (typically) invisible to software.

For the first stack, each environment 20 has to pre-allocate a memory area greater than or equal to the maximum number of interrupt vectors simultaneously enabled for the runtime environment plus one multiplied by the processor 14 state size. The “plus one” term corresponds to the case when the processor 14 runs ordinary, non-ISR code in the given environment.

Furthermore, while servicing an interrupt, any of the disabled interrupt vectors can be re-enabled only if there is room in the first stack. This can happen either because the runtime environment 20 over-allocated memory for the stack, e.g. more than the number of interrupts +1.

Alternatively, one could have a processor 14 architecture that allocates memory for an extension of the first hardware-managed stack 16 dynamically, upon request from software. Before enabling an interrupt serviced in the current environment 20, the ISR can check the availability of the necessary entry in the hardware-managed stack 16. Hardware 16 manages the transitions between the original stack to an extension and back or between extensions.

The maximum number of entries in the second hardware-managed stack 16, under the assumption that interrupts are never re-enabled, is equal to the number of ISR in the current environment 20: each entry in a runtime environment that needs to return back to a different environment corresponds to an interrupt. To enable interrupts, the hardware-based mechanisms for managing the second stack are extended as for the first stack if ISR software is allowed. These two ‘logical’ stacks can be physically implemented using two separate memory regions or they can be combined into one hardware managed stack 16 with alternating entries, big and small.

In an alternate embodiment, the first logical stack can be combined with the software-managed interrupt stack, as there is nothing on the first stack that the software should not have access to. On processor architectures that assign a register as a stack pointer, this is a natural implementation; on the rest, merging the first hardware-managed stack with the software-managed interrupt stack is significantly more difficult.

If the two hardware managed stacks are kept separate, system 10 can explore the question of whether software should have read (or even write) access to the second stack, storing the IDs of the interrupted environments, and each of the four answers (no access, read, write, and/or read/write) translates into an alternate embodiment.

Option D: there is one hardware-managed stack 16 per system 10 to store the ID of the interrupted environment. This system-wide stack, which is invisible to software, replaces the 2nd hardware managed stack per environment 20 that was described in option C.

For each runtime environment 20, system 10 still has a hardware-managed stack 16 to store the processor 14 state upon interrupt, when the ISR belongs to a different environment, e.g. before switching environments. This is the same with the 1st hardware managed stack 16 in option C and it can be implemented separately from, or merged with the software-managed stack of the environment 20, as already described under option C.

System 10 also addresses the sizing of hardware-managed stacks/trusted areas 16. For option A, the mechanism is designed such that the size of the trusted areas 16 used for saving processor 14 state does not exceed the size of the processor state multiplied by the maximum number of distinct runtime environments 20 used while servicing external interrupts. For option B, the mechanism is designed for efficiency and the size of the hardware-managed stack 16 is selected such that there is no overflow during normal operation.

The amount of memory required for option A and B could be smaller when there are trust relationships between some of the runtime environments 20. For instance, in the common/current case of two state (user and superuser, or application and kernel modes), there may be no need for extending the processor 14 with trusted areas because it is considered safe to save application processor state in a kernel mode stack and because all device drivers are hosted by the kernel environment.

Note that in a multiprocessor 14, each processor has its own trusted hardware-managed areas 16, for each of the options above. In a multicore environment, each core has separate hardware-managed areas 16.

The system 10 is designed such that it does not require any changes to the existing device driver implementations. The processor 14 keeps track of the state saved locally and it handles the execution of RFI instructions accordingly. When the processor 14 state is saved automatically, in hardware, and cleared after being saved in the trusted area (options B and C), an unmodified device driver executes a couple of unnecessary instructions to save and restore the cleared state in/from the local stack. This overhead can be identified and reduced if the device driver code can be modified.

If debugger support is needed, the debugger component can run in the most trusted environment 20 to read and modify the trusted areas 16. When debugger support is not needed, this capability can be disabled.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
a computer processor to process software running in a plurality of runtime environments;
an interrupt stack per runtime environment to assist in how the computer processor switches from one subroutine to another in the same environment and from one runtime environment to any of the other runtime environments; and
a plurality of hardware-managed areas to store processor state information and to assist in how the computer processor switches from one runtime environment to any of the other runtime environments.

2. The system of claim 1 wherein the computer processor applies extensions to the processor state information that indicate which processor state information should be stored in the hardware-managed area instead of the interrupt stack.

3. The system of claim 1 wherein the computer processor applies extensions to the processor state information that indicate which runtime environment the processor was executing software in before transitioning to the current runtime environment.

4. The system of claim 1 wherein the hardware-managed area comprises a memory that cannot be referenced by software.

5. The system of claim 1 wherein the hardware-managed area comprises a memory that cannot be referenced by software other than when running in a trusted runtime environment.

6. The system of claim 1 wherein the number of runtime environments includes one environment assigned for all applications in the system.

7. The system in claim 1 wherein the hardware-managed area comprises at least one of a plurality of memory areas, each runtime environment is assigned one of the hardware-managed areas, and the size of each of the memory areas is substantially equal to the size of a processor state.

8. The system in claim 7 wherein upon a change in the runtime environment, a fraction of the memory area assigned to a currently executing environment is used to save the processor state except for the processor state information that identifies the currently executing environment and a fraction of the memory area assigned to the next runtime environment is used to save a processor state that identifies the currently running environment.

9. The system in claim 4 wherein the size of the hardware-managed memory area is at least a multiple of the processor state and the memory area is used as a stack when the processor changes runtime environments.

10. The system in claim 5 wherein the hardware-managed memory area's size is at least a multiple of the processor state and the memory area is used as a stack when the processor changes runtime environments and software running in a trusted environment handles stack overflow conditions using memory areas accessible to software running in the trusted environment.

11. The system in claim 4 wherein the hardware-managed area comprises a plurality of smaller memory areas and each runtime environment is assigned two such areas, and where both areas are managed as stacks, and where the size of the first area is at least the size of the processor state other than information regarding the currently executing environment multiplied by a number of exception vector handlers assigned to the environment and where the size of the second area is at least the size of the processor state identifying the currently executing environment multiplied by the number of exception vector handlers assigned to the environment.

12. The system of claim 1 wherein the interrupt stacks and hardware-managed area comprise non-pageable memory.

13. A method comprising:
configuring a computer processor to process software running in a plurality of runtime environments;
using an interrupt stack per runtime environment to assist in how the computer processor switches from one subroutine to another in the same environment and from one runtime environment to any of the other runtime environments; and
configuring a plurality of hardware-managed areas to store processor state information and to assist in how the computer processor switches from one runtime environment to any of the other runtime environments.

14. The method of claim 13 further comprising applying extensions to the processor state information that indicate which processor state information should be stored in the hardware-managed area instead of the interrupt stack.

15. The method of claim 13 further comprising applying extensions to the processor state information that indicate which runtime environment the processor was executing software in before transitioning to the current runtime environment.

16. The method of claim 13 further comprising preventing the hardware-managed area from being referenced by software.

17. The method of claim 13 further comprising preventing the hardware-managed area from being referenced by software other than when running in a trusted runtime environment.

18. The method of claim 13 further comprising including in the number of runtime environments one environment assigned for all applications in the system.

19. The method of claim 13 further comprising providing at least one of the hardware-managed area as a plurality of memory areas, assigning each runtime environment one of the hardware-managed areas, and sizing each of the memory areas as substantially equal to the size of a processor state.

20. A system comprising:
a computer processor to process software running in a plurality of runtime environments;
an interrupt stack per runtime environment to assist in how the computer processor switches from one subroutine to another in the same environment and from one runtime environment to any of the other runtime environments; and
a plurality of hardware-managed areas comprising a memory that cannot be referenced by software that stores processor state information and assists in how the computer processor switches from one runtime environment to any of the other runtime environments, and the number of runtime environments includes one environment assigned for all applications in the system.

21. The system of claim 20 wherein the computer processor applies extensions to the processor state information that indicate which processor state information should be stored in the hardware-managed area instead of the interrupt stack.

22. The system of claim 20 wherein the computer processor applies extensions to the processor state information that indicate which runtime environment the processor was executing software in before transitioning to the current runtime environment.

23. The system of claim 20 wherein the hardware-managed area comprises a memory that cannot be referenced by software other than when running in a trusted runtime environment.

24. The system in claim 20 wherein the hardware-managed area comprises at least one of a plurality of memory areas, each runtime environment is assigned one of the hardware-managed areas, and the size of each of the memory areas is substantially equal to the size of a processor state.

25. The system in claim 20 wherein upon a change in the runtime environment, a fraction of the memory area assigned to a currently executing environment is used to save the processor state except for the processor state information that identifies the currently executing environment and a fraction of the memory area assigned to the next runtime environment is used to save a processor state that identifies the currently running environment.
